(19) United States
(12) Patent Application Publication
(10) Pub. No.: US 2019/0325696 A1
(43) Pub. Date: Oct. 24, 2019

(54) Scratch-Off Lottery Ticket System and Method with Visually Enhanced Digital Game Play Area

(71) Applicant: Scientific Games International, Inc., Newark, DE (US)

(72) Inventor: Jeffrey D. Martineck, SR., Johns Creek, GA (US)

(21) Appl. No.: 15/958,146

(22) Filed: Apr. 20, 2018

(51) Int. Cl. G07F 17/32

(52) U.S. Cl. CPC G07F 17/3223; G07F 17/323; G07F 17/3211; G07F 17/329

(57) ABSTRACT

An instant lottery ticket game system and method wherein a master instant lottery tickets for a common game a game play area with variable game play indicia, and static game instruction indicia in a master language. Each master ticket includes a ticket-specific code thereon that links the master instant lottery ticket to a ticket-specific computer file in a central server. For each master ticket, a digital game play area is generated corresponding to the game play area of the master ticket and stored in the ticket-specific computer file. The central server downloads the digital game play area to the smart device upon receipt of the ticket-specific code for a specific one of the master tickets. In the digital game play area, winning game play indicia therein is marked in a manner recognizable by an application on the smart device, wherein the application visually enhances the marked winning game play indicia.

### FIELD OF THE INVENTION

The present invention generally relates to a system and method for implementing a scratch-off (“instant”) lottery ticket game, and more particularly to a method and system for facilitating easier reading and confirmation of winning game indicia in play of such games.

### BACKGROUND

“Scratch-off” or “instant-win” lottery tickets have enjoyed immense popularity in the lottery industry for decades. These games offer distinct advantages to the lottery authorities and are attractive to a broad spectrum of players.

As conventional scratch-off games have grown in complexity, potential prize awards, and entertainment features, the size of the game play indicia has decreased in order to still offer the games on the same size substrate. In other words, the “real estate” of the ticket has not grown, but the volume and complexity of game play indicia in the game play area has increased, resulting in smaller, harder-to-read, and more complex game play indicia.

For a certain segment of the public, the smaller game play indicia is problematic. Those with poorer eyesight can become frustrated by the decreased ability to quickly ascertain the winning or losing status of the ticket, and may shy away from playing the tickets.

For others, the complexity of the games and game play indicia can be intimidating, and such people may not be comfortable relying on themselves to determine the winning or losing status of the tickets. These customers are hesitant to discard tickets and typically turn the tickets in to the retailer for scanning and confirmation of the ticket status.

The above scenarios are obviously disadvantageous. The industry and public would benefit from improved methods and game systems to facilitate easier play of scratch-off lottery tickets having smaller and more complex game play indicia.

### SUMMARY

Objects and advantages of the invention will be set forth in part in the following description, or may be obvious from the description, or may be learned through practice of the invention.

In a particular embodiment, an instant lottery ticket game system and method includes a set of master instant lottery tickets (“master tickets”) for a common game. The master instant lottery tickets may be printed paper tickets, or may be electronically simulated tickets that are transmitted to and played by the player via an application running on a smart device, such as a mobile phone, tablet, computer, etc. The master tickets are produced for a single common game, for example all of the tickets produced for a common game identified by a single name (e.g., “Lucky Seven” instant scratch-off tickets). Such tickets may be produced under multiple production runs, wherein the prize structure for the expected value of the common game is implemented by winning tickets distributed throughout the production run(s).

Each master ticket includes a game play area with variable game play indicia that determines whether or not the ticket is a winning or losing ticket. The game play indicia is “variable” in that it changes from one ticket to the next. The game play area is covered by a removable scratch-off coating (SOC) layer, as is well-known in the industry. Each master ticket also includes static game instruction indicia (words and graphics) that does not change and is common to all of the master tickets in the common game. This indicia generally instructs the player on how to play the game, the potential prizes, and so forth.

Each master ticket further includes a ticket-specific code (e.g., a bar code or alpha-numeric code) thereon that links the master instant lottery ticket to a ticket-specific computer file that is stored with a central server (e.g., in the central server or accessible by the central server)

For each master ticket, a digital game play area is generated that corresponds to the game play area of the respective master instant lottery ticket, wherein the digital game play is stored in the ticket-specific computer file.

The central server is configured for communication with a player's smart device. Via an application running on the smart device, the player scans or otherwise enters the ticket-specific code. Upon receipt of the code, the central server downloads the respective digital game play area for the master ticket to the smart device.

The digital game play area is specifically configured such that winning game play indicia therein is marked or tagged in a manner recognized by the application on the smart device, wherein such application then visually enhances the marked game play indicia in an image of the digital game play area that is presented to the player via the smart device.

In a particular embodiment, the digital game play area is a digital image and the winning game play indicia is marked with a character or symbol that is recognized by character recognition capability of the application running on the smart device. The character or symbol can be embedded in the game play indicia or set apart from the game play indicia within a defined area or distance.

In an alternative embodiment, the digital game play area is a digital image and the winning game play indicia is marked with a font or color that differentiates the winning game play indicia from non-winning game play indicia and that is recognized by the application running on the smart device.

Visual enhancement of the winning game play indicia can take place in various ways. In one embodiment, the winning game play indicia is significantly magnified or enlarged as compared to the non-winning game play indicia, and may be further set out, for example in a magnified bubble-like view.

Embodiments of the present system and method may also encompass providing a visually enhanced indication in the digital game play area of a non-winning master ticket in the event that the application running on the smart device does not detect winning game play indicia. This indication may be a message or other suitable graphics/indicia presented in an enlarged field in the digital game play area.

In further embodiments, the system and method may also include generation of a digital game instruction area that contains the static game instruction indicia for the common game and is also presented to the player with the digital game play area on the smart device. This digital game instruction area may be combined and stored with the digital game play area in the ticket-specific computer file at the central server such that essentially a complete digital image of the master ticket is stored in the ticket-specific computer file or generated by the player's smart device by combining the two areas.

However, it may be desired that the ticket-specific computer file be limited to storage and transmission of only ticket-specific data and information. Thus, in alternate embodiments, the digital game instruction area may be generated as a digital template for the common game that contains the static game instruction indicia, wherein the digital template downloaded by the central server and stored on the player's smart device. With this configuration, only the digital game play area for the specific master ticket need be transmitted to the smart device by the central server upon receipt of the ticket-specific code. The application on the smart device functions to combine or overlay the digital template on the digital game play area so that the player is presented with an essentially complete digital image of the master ticket with the winning game play indicia displayed in the visually enhanced manner.

In certain embodiments of the system and method, the ticket-specific code on the master ticket is the validation code and the ticket-specific computer file is a validation file at the central server that contains ticket-specific information for validation and redemption of the master instant lottery ticket, as commonly understood in the industry. The digital game play area can be stored in the validation file for the master instant lottery ticket, and may be combined with the digital game instruction area.

The system and method also contemplate that each master ticket is specifically configured to include an easily and universally recognized symbol printed thereon that indicates to players that the visually enhanced version of the master ticket is available to the player via their smart device.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 depicts a master instant lottery ticket that may be used with the game systems and methods according to an exemplary embodiment of the present invention;

FIG. 2 depicts the digital game play area combined with a digital template of the game instruction indicia to present a digital image of the master ticket on a player's mobile smart device;

FIG. 3 depicts the digital image of the master ticket of FIG. 2 with the winning game play indicia visually enhanced by the mobile smart device;

FIG. 4 depicts a digital image of a master ticket on the player's mobile smart device with a visually enhanced indication that there are no winning game indicia in the game play area;

FIGS. 5a and 5b depict embodiments of marking of winning game play indicia in a manner that is recognized by the player's smart device for subsequent visual enhancement (enlargement);

FIG. 6 is a block diagram of a system component and method configuration according to an embodiment of the invention;

FIG. 7 is a block diagram of a system component and method configuration according to an alternate embodiment of the invention;

FIG. 8 is a flow diagram according to an embodiment of the invention; and

FIG. 9 is a flow diagram according to an alternate embodiment of the invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

Generally, the present disclosure is directed to a computer-based instant lottery ticket game system and associated method that enables a visually enhanced (e.g., magnified or enlarged) view of the game play area of a master ticket via a smart device (e.g., a mobile phone) so that a player can more easily see the game play indicia that indicates the winning or losing status of the master ticket. The system and method should have appeal to players and retailers for its ease of operation and versatility, particularly for players that find it difficult to see or read the game play indicia on the master tickets.

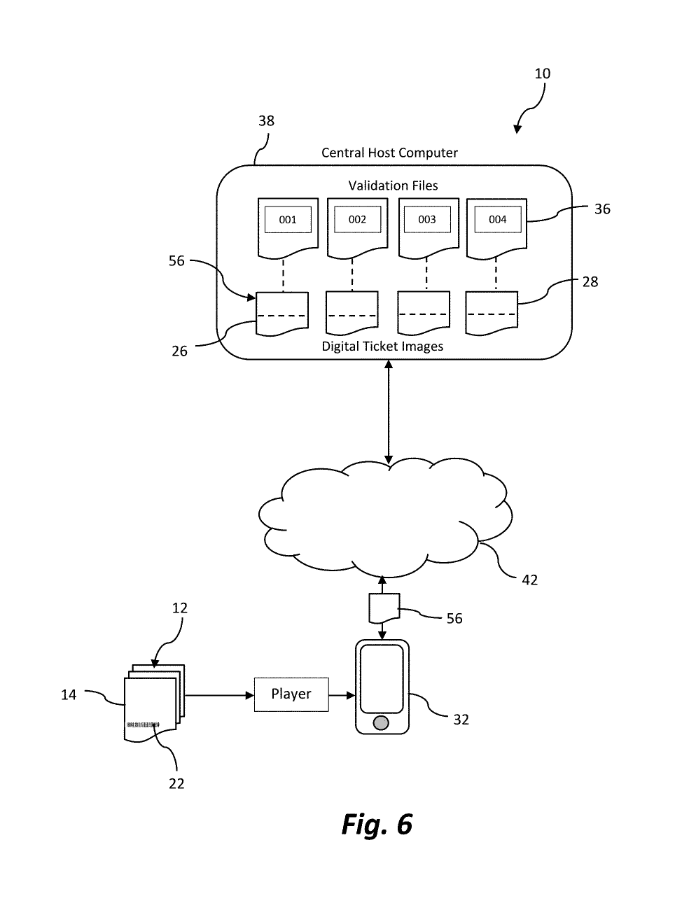

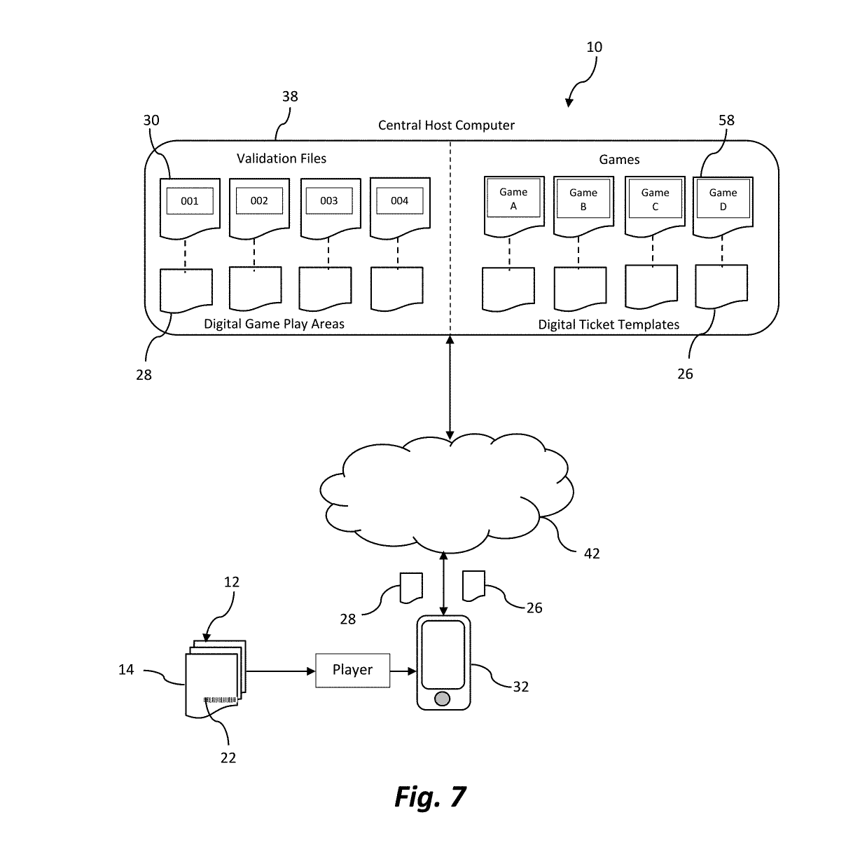

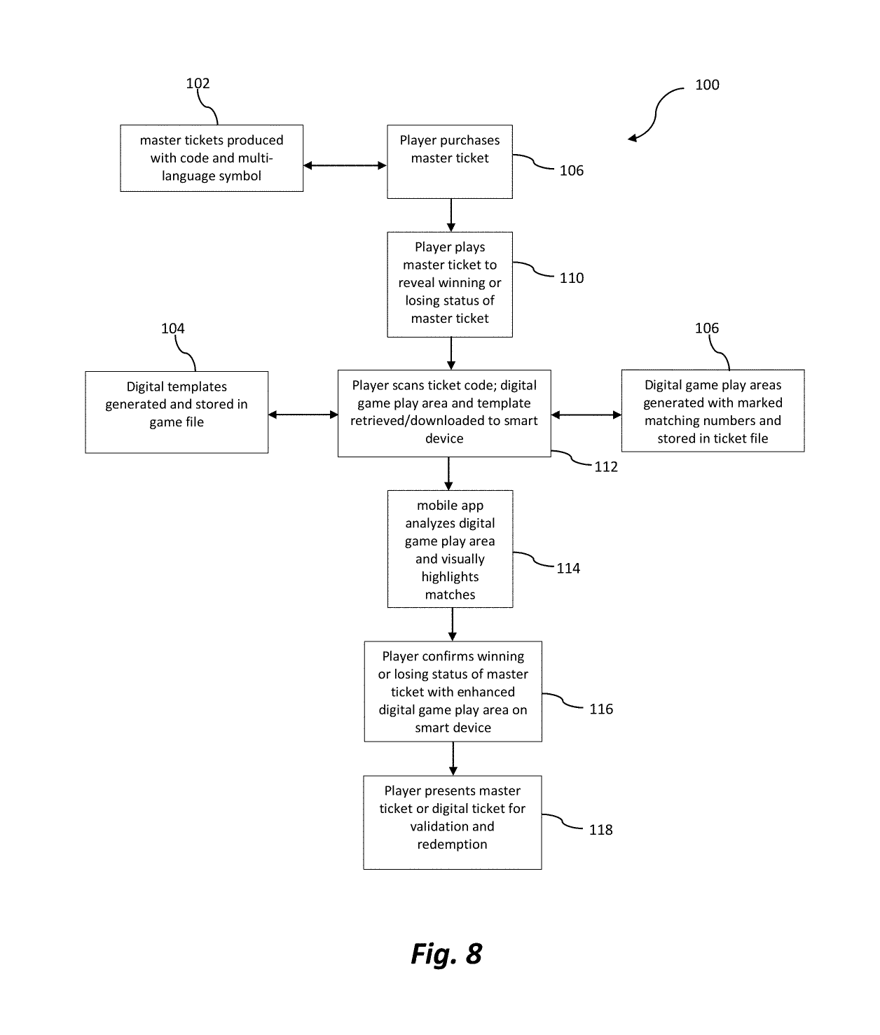

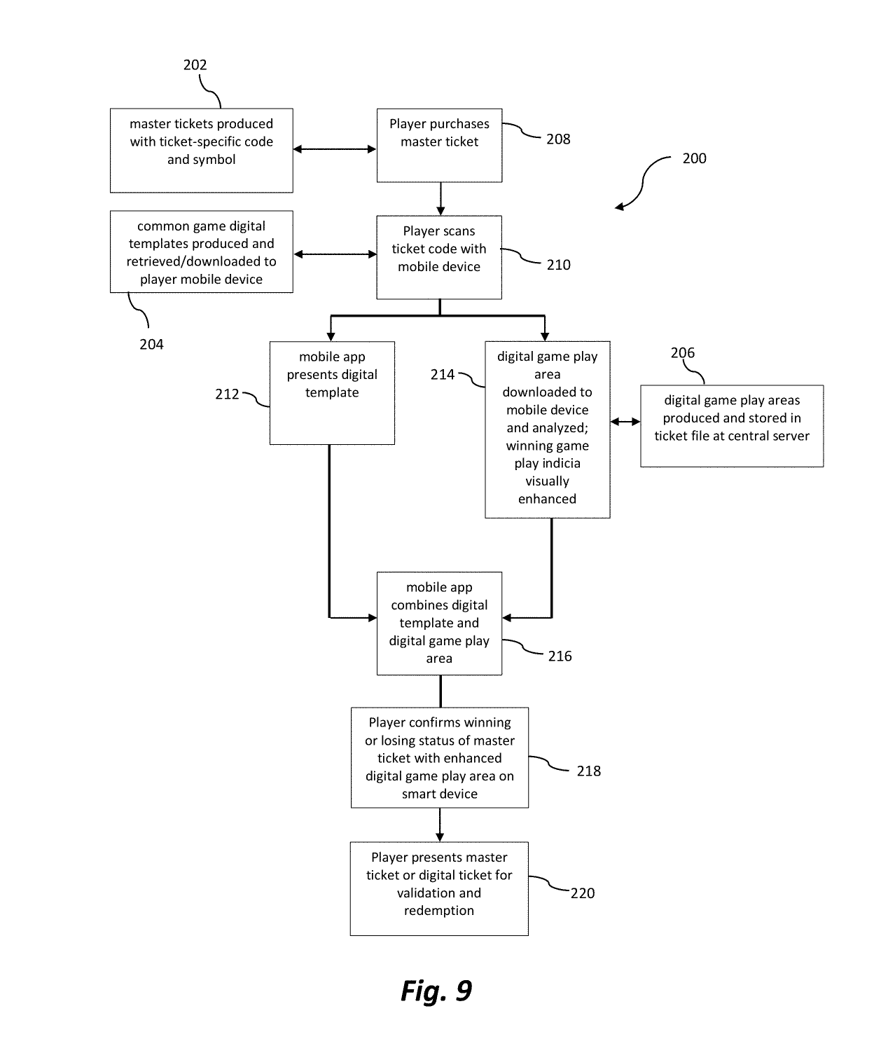

In a particular embodiment depicted in the figures, an instant lottery ticket game system 10 (FIGS. 6 and 7) and associated method 100, 200 (FIGS. 8 and 9) are provided wherein a set 12 of individual master instant lottery tickets 14 (“master tickets”) are produced. Those skilled in the art appreciate that a set 12 of such tickets 14 may be the entire lot of tickets (produced over the course of one or more production runs) for a given common game, wherein the prize structure that generates the expected value for the common game is embodied by winning tickets 14 distributed throughout the ticket lot. In other embodiments, the set 12 may be a subset of the entire lot of tickets for the common game.

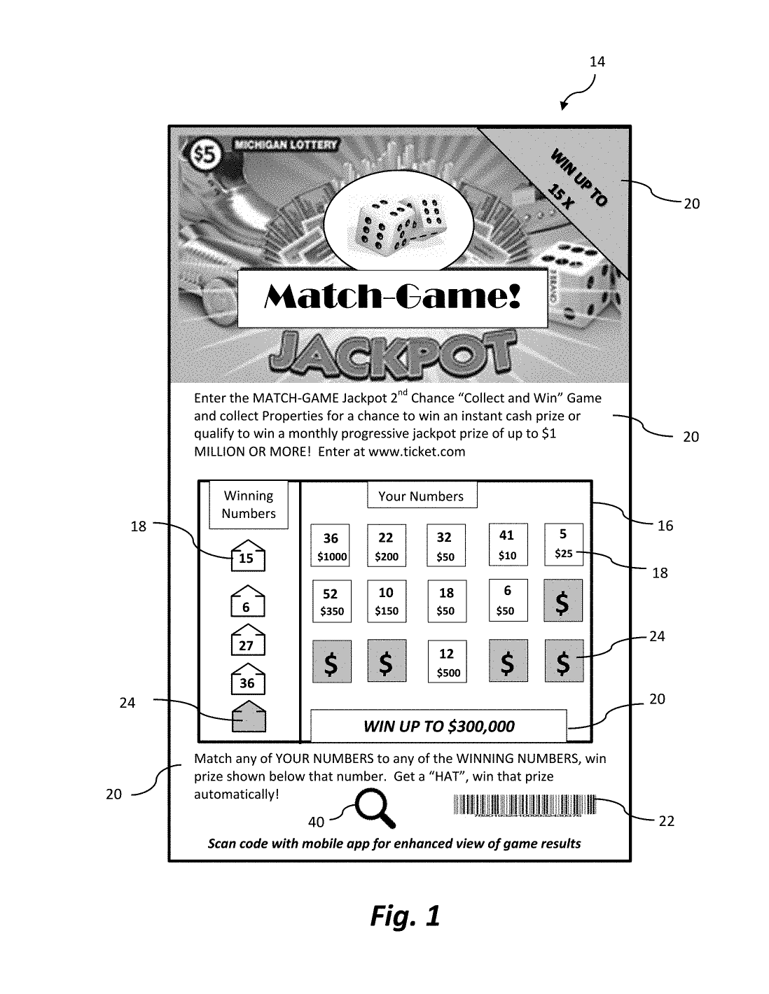

Referring to FIG. 1, an exemplary master ticket 14 is depicted. The master ticket 14 includes game instruction graphics and indicia 20 printed in a master language, such as English. Such indicia 20 explains to a player in the master language how to play the game embodied on the master ticket 14, as well as what constitutes a winning ticket and the prize amounts. The game instruction indicia 20 may be considered as “static” indicia in that, for a given common game, it does not change from one ticket 14 to the other. Thus, the set 12 of master tickets 14 are for a common game that has the same game instruction indicia 20. For example, in the depicted embodiments, the common game is a “Match-Game Jackpot” instant scratch-off lottery game.

The master tickets 14 may be printed paper tickets, or may be electronically simulated tickets 14 that are transmitted to and played by the player via an application running on a smart device 32 (FIGS. 6-7), such as a mobile phone, tablet, computer, etc.

Still referring to FIG. 1, and as is well-known to players of instant scratch-off lottery tickets, each master ticket 14 includes a game play area 16 wherein variable game play indicia 18 is provided and covered by a scratch-off coating (SOC) layer 24. In order to reveal the winning or losing status of the master ticket 14, the player removes the SOC layer 24 to uncover the underlying game play indicia 18. Thus, the game play indicia 18 is “variable” indicia in that it changes from one master ticket 14 to another. In the depicted common game embodied by the master tickets 14 in the figures, the player is presented with a series (5) of “Winning Numbers” in the left-hand side of the game play area 16 covered by the SOC layer 24. A matrix of “Your Numbers” is provided in the right-hand side of the game player area 16. The game instruction indicia 20 conveys to the player that a match of any of the “Your Numbers” with any of the “Winning Numbers” wins the prize show below the number, as well as other prize potentials. Additional game instruction indicia 20 instructs the player on how to enter a second-chance game.

In the embodiment of FIG. 1, each master ticket 14 includes a ticket-specific code 22 printed thereon, such as a scannable barcode (as depicted in the figures) or alpha-numeric code. The code 22 is a code that links or associates the master ticket 14 to a ticket-specific computer file 30 at a central server 38 (FIGS. 6 and 7), as described in greater detail below. The code 22 may also identify the master ticket 14 with the common game and common game instruction indicia 20. Thus, it should be appreciated that the ticket-specific code 22 may include game identifying portions or components that are common for all of the codes 22 for master tickets 14 belonging to a common game.

Generally, conventional instant lottery tickets include a validation code printed thereon, which may also be covered by a SOC layer 24, that links the ticket to a validation file 36 (FIG. 6) contained in the central server 38 (or otherwise accessible by the central server 38). Those skilled in the art appreciate that the validation file 36 contains ticket-specific information for validation and pay-out (redemption) of the master ticket 14. In certain embodiments of the present system and method, the function of the ticket-specific code 22 is served by the validation code for the master ticket 14. However, in alternate embodiments, the ticket specific code 22 is separate from the validation code, which may be desirable for security reasons.

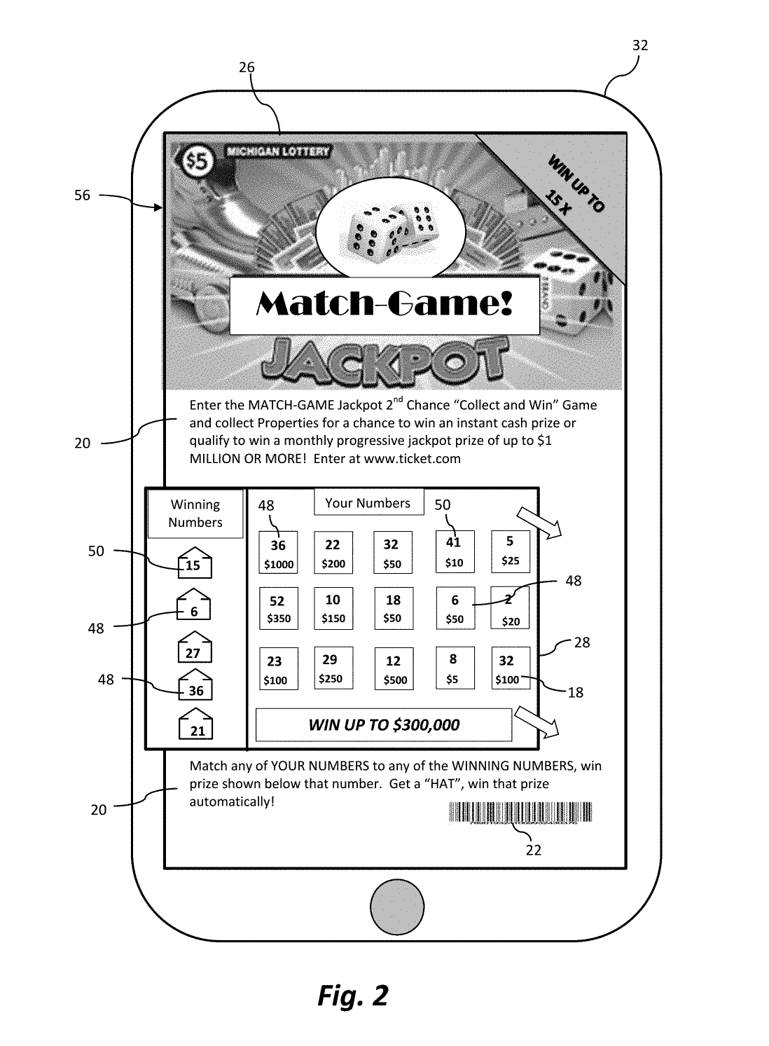

For each master ticket 14, a digital game play area 28 is generated that corresponds to the game play area 16 of the respective master ticket 14, wherein the digital game play is stored in the ticket-specific computer file 30. Comparing FIGS. 1 and 2, it is seen that the digital game play area 28 in FIG. 2 corresponds essentially with the game play area 16 of the master ticket 14 in FIG. 1 with all or part of the SOC layer 24 removed from the variable game play indicia 18. Thus, the digital game play area 28 can reveal both winning game play indicia 48 and non-winning game play indicia 50.

In FIG. 2, the digital game play area 28 is depicted as being downloaded to the player's mobile smart device 32. In certain embodiments, the digital game play area 28 may be displayed via the smart device 32 as a stand-alone image. In other embodiments, as shown in FIG. 2, the digital game play area 28 is combined with a template 26 that includes an image of the static game instruction indicia 20 so that an essentially complete digital ticket image 56 is presented to the player, as described in greater detail below.

Referring to FIGS. 6 and 7, the central server 38 (host computer) is configured for communication with the player's smart device 32. Via an application running on the smart device 32, the player scans or otherwise enters the ticket-specific code 22 from the master ticket 14 purchased by the player. Upon receipt of the code 22, the central server 38 retrieves the corresponding digital game play area 28 for the master ticket 14 from the ticket-specific file 30 and downloads the digital game play area 28 to the smart device 32.

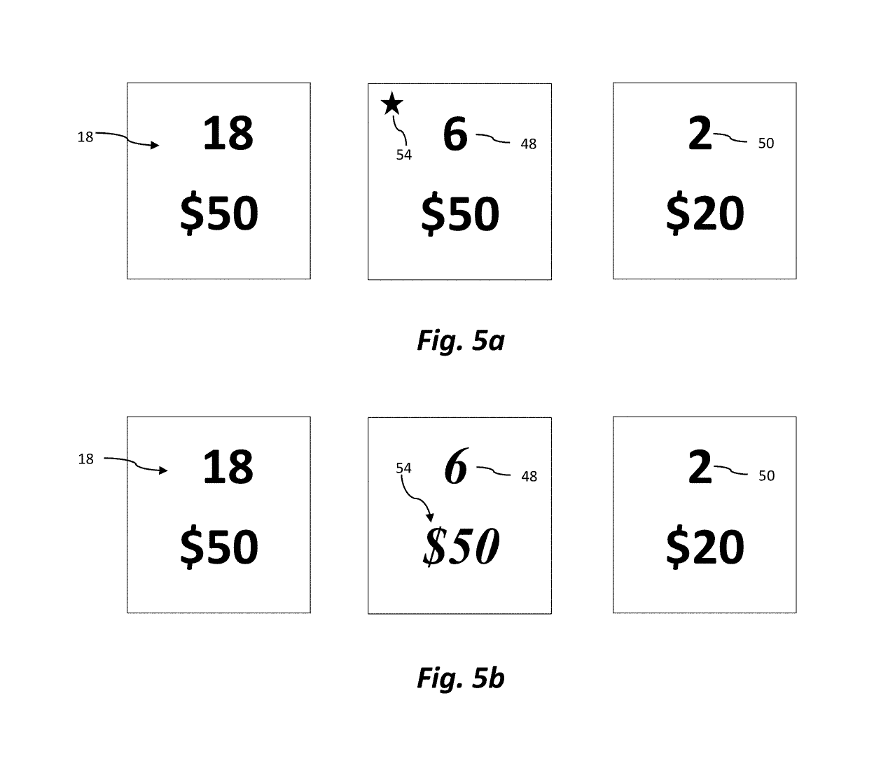

The digital game play area 28 is specifically configured such that winning game play indicia 48 contained therein is marked in a manner recognizable by the application on the smart device 32. In other words, the smart device 32 is capable of detecting the mark and discerning winning game play indicia 48 from non-winning game play indicia 50. This marking functionality can be accomplished in various ways. For example, referring to FIG. 5a, a digital mark 54 can be placed on or near the winning game play indicia 48 that is recognized by the application on the smart device. This mark 54 can, for example, be any manner of character or symbol that is placed within a defined distance (a search field) from the winning game play indicia 48, such as anywhere within the “box” that contains the winning or non-winning game play indicia 48, 50. The character or mark 54 could also be embedded within the winning game play indicia 48. In an alternate embodiment, the mark function is served by changing the font, size, color, or other aspect of the winning game play indicia 48 as compared to the non-winning game play indicia 50. For example, in FIG. 5b, the font of the winning game play indicia 48 is different from that of the non-winning game play indicia 50.

In order to detect the marks 54, the smart device 32 may utilize digital image analysis software provided by the application running on their device 32 (or otherwise provided by the smart device 32). A number of commercially available digital image software analysis programs are available that can be readily configured or modified by those skilled in the art for the systems and methods described herein, and a detailed discussion of digital image analysis is not necessary for an understanding of the present invention.

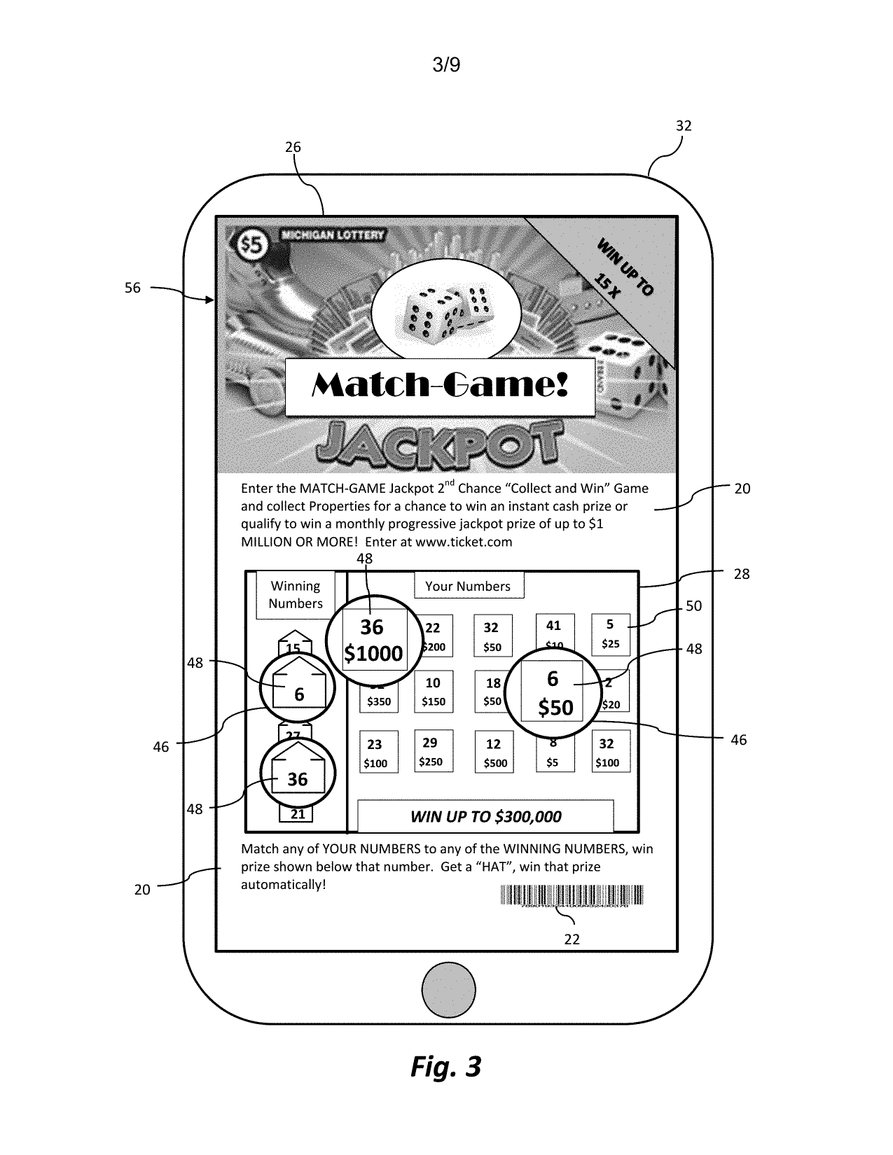

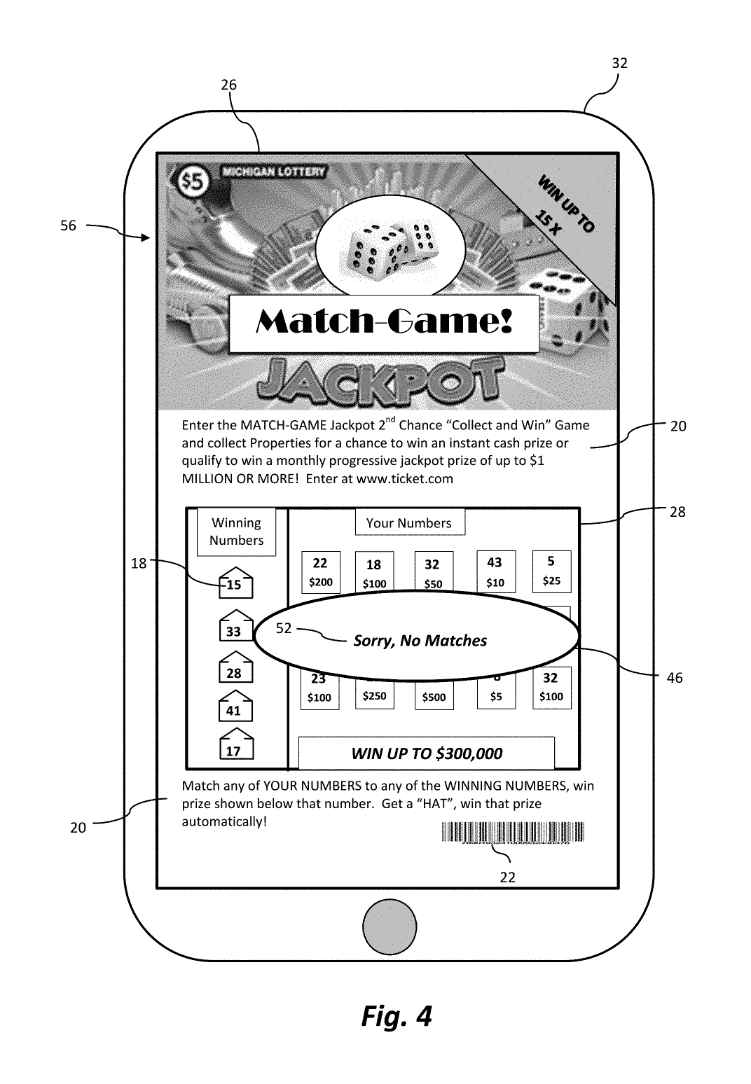

Referring to FIGS. 3 and 4, once winning game play indicia 48 is detected by the application on the smart device 32, the application proceeds to visually enhance the marked game play indicia 48 in the image of the digital game play area 28 presented to the player via the smart device 32. This “visual enhancement” is done in a manner that renders the winning game play indicia 48 easier for the player to see as compared to the non-winning game play indicia 50. For example, the winning game play indicia 48 could be highlighted with a bright color background, or the color of the winning game play indicia 48 could be different from that of the non-winning game play indicia 50, and so forth. In the embodiment depicted in FIG. 3, the winning game play indicia 48 is drawn-out and displayed in an enlarged field 46, such as a bubble field, that magnifies the winning game play indicia 48.

Referring to FIG. 4, embodiments of the present system and method may also encompass providing a visually enhanced indication 52 of a non-winning master ticket 14 in the event that the application running on the smart device 32 does not detect winning game play indicia 48. The indication 52 may be a message or other suitable graphics/indicia presented in an enlarged field 46, as depicted in FIG. 4.

As mentioned above, the system and method may also include generation of a digital game instruction area or template 26 that contains the static game instruction indicia 20 for the common game and is also presented to the player with the digital game play area 28 on the smart device 32, as depicted in FIGS. 2 through 4. A digital template 26 is produced for each common game and may be initially stored in a database at the central server 38 (including a database accessible by the central server 38).

Referring to FIG. 7, the central server 38 may initially store the digital template 26 for each common game (e.g., common games A-D) in common am files 58 separate from the ticket-specific computer files 30 and download the digital templates 26 via the application running on the player's smart device 32, wherein the digital templates 26 are then stored on the player's smart device 32. This download of a digital template 26 for one of the common games may happen at the first instance when the player enters the ticket-specific code 22 from a master ticket 14 associated with the common game. Alternately, the download of templates 26 for one or more of the common games may happen automatically with periodic updates to the application loaded on the player's smart device 32, or when initiated by the player. With these configurations, only the digital game play area 28 for the specific master ticket 14 need be transmitted to the smart device 32 by the central server 38 upon receipt of the ticket-specific code 22. The application on the smart device 32 functions to combine or overlay the digital template 26 on the digital game play area 28 so that the player is presented with an essentially complete digital image 56 of the master ticket 14 with the winning game play indicia 48 displayed in the visually enhanced manner as discussed above.

In an alternate embodiment, the digital templates 26 are not downloaded and stored in the player's smart device 34, but are individually transmitted by the central server 38 to the smart device upon receipt of the code 22 from the smart device 32.

In the embodiment of FIG. 6, the digital game instruction template 26 may be combined and stored with the digital game play area 28 in the ticket-specific computer file 30 for each master ticket 14 at the central server 38. With this embodiment, essentially a complete digital image 56 of the master ticket 14 is stored in the ticket-specific computer file 30, retrieved by the central server 38 upon receipt of the ticket-specific code 22, and downloaded to the player's smart device 32.

As discussed above, the ticket-specific computer code 22 provided on the master ticket 14 links the master ticket 14 to the ticket-specific computer file 30 at the central server 38. The code 22 may contain the common game identification data needed to retrieve the digital template 26 and the ticket specific data needed to retrieve the digital game play area 28. A validation code (or modified validation code) may serve this function, as depicted in FIGS. 1, 6, and 7. For example, if the ticket-specific code 22 also functions as the ticket validation code, wherein the ticket-specific computer file 30 is also the validation file 36 (FIG. 6) associated with the master ticket 14 at the central server 38, then the digital game play area 28 is stored in the validation file 36.

The system 10 and method 100, 200 also contemplate that each master ticket 14 is specifically configured to include an easily and universally recognized symbol 40 printed thereon, such the magnifying glass symbol in FIG. 1 or any other suitable indicia (including words and/or graphics), that indicates to players that the visually enhanced digital game play area option is available for the master ticket 14.

FIGS. 6 and 7 depict the player's smart device 32 in communication with the central (host) server 38 via any suitable communications network 42. The network 42 can be any type of communications network, such as a local area network (e.g. intranet), wide area network (e.g. Internet), or some combination thereof. The network can also include a direct connection between the player mobile device 32 and the host server 38. In general, communication between the host server 38 and player mobile device 32 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

It should be appreciated that the host server 38 can include a network interface for providing communications over the network 42. A network interface can include any suitable components for interfacing with one more networks, including for example, transmitters, receivers, ports, controllers, antennas, or other suitable components.

The host server 38 can be any computing device and can include one or more processors and one or more computer-readable media. The computer-readable media can store instructions which cause the processor to perform the operations described herein, as well as other functions related to conduct of the overall game for the lottery authority.

The player's smart device 32 can be any portable computing device that can be used by a player to interface with the host server 38. For instance, the device 32 can be a wireless device, a personal digital assistant (PDA), portable gaming device, cellular phone, smart phone, tablet, navigation system, handheld GPS system, wearable computing device, a display having one or more processors, or other such device. In short, the player's smart device 36 can be any computer-device or system that can execute a gaming module to allow a player to interact with the host computer 38 as described herein.

The technology discussed herein makes reference to servers, computers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

FIG. 8 depicts an embodiment of a method 200 in accordance with the invention, aspects of which are discussed above.

At step 102, the master language tickets 14 are produced with the ticket-specific code 22 and symbol 40 provided thereon.

Step 104 depicts generation of the common game instruction digital templates 26, which are initially stored at the central server 38.

Step 106 depicts generation of the ticket-specific digital game play areas 28 with the marks 54 to distinguish winning game play indicia 48 from non-winning game play indicia 50.

At step 108, the player purchases one or more of the master tickets 14 (paper or electronic).

At step 110, the player may play the master ticket 14 by physically removing the SOC layer 24 from the game paly indicia in the game play area of the ticket to reveal the winning or losing status of the ticket. It should be appreciated, however, that this step may be omitted, and that the player may rely on the visually enhanced game play area 28 presented on their smart mobile device 32 to determine the status of the ticket. In other words, it is not required that the player actually play the physical master ticket 14.

At step 112, the player scans or otherwise enters the ticket-specific code 22 from the master ticket 14 into their smart device 32 via the application running on the smart device 32. At this time, the common game digital template 26 may be downloaded to the smart device 32, or retrieved from memory by the smart device 32 is previously downloaded.

At step 114, the application on the smart device 32 analyzes the digital game play area 28 and visually enhances winning game play indicia.

At step 116, the player confirms the winning or losing status of the master ticket 14 by viewing the visually enhanced digital game play area 28 of the digital ticket image 56 on their smart device 32.

At step 118, the player presents the master ticket 14 or the digital image 56 (if it includes the ticket validation code) for validation and redemption of a wining master ticket 14.

FIG. 9 depicts an alternate embodiment of a method 200 associated with FIG. 7.

At step 202, the master language tickets 14 are produced with the ticket-specific code 22 and symbol 40 provided thereon.

Step 204 depicts generation of the common game instruction digital templates 26, which are initially stored at the central server 38 and subsequently downloaded to the player's mobile device 32.

Step 206 depicts generation of the ticket-specific digital game play areas 28 with the marks 54 to distinguish winning game play indicia 48 from non-winning game play indicia 50, with digital game play areas 28 stored in the ticket-specific computer file 30 at the central server 38.

At step 208, the player purchases one or more of the master tickets 14 (paper or electronic).

At step 210, the player scans or otherwise enters the ticket-specific code 22 from the master ticket 14 into their smart device 32 via the application running on the smart device 32.

At step 212, the digital template 26 corresponding to the common game of the master ticket 14 is retrieved by the smart device 32 (if previously downloaded) or downloaded from the central server 38.

At step 214, the digital game play area 28 for the master ticket 14 is retrieved by the central server 38 from the ticket-specific computer file 30 (e.g., the validation file) and downloaded to the player's mobile smart device 32. The application on the smart device 32 analyzes the digital game play area 28 and visually enhances winning game play indicia 48 in the digital game play area 28.

At step 216, the mobile smart device 32 combines the digital template 26 and digital game play area 28 into a digital ticket image 56 of the master ticket 14 with the winning game indicia 48 visually enhanced.

At step 218, the player confirms the winning or losing status of the master ticket 14 by viewing the visually enhanced digital game play area 28 of the digital ticket image 56 on their smart device 32.

At step 220, the player presents the master ticket 14 or the digital image 56 (if it includes the ticket validation code) for validation and redemption of a wining master ticket 14.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. An instant lottery ticket game system, comprising:
a set of master instant lottery tickets for a common game, wherein each master instant lottery ticket comprises static game instruction indicia that is common to all of the master instant lottery tickets in the common game and a game play area with variable game play indicia;
each of the master instant lottery tickets further comprising a ticket-specific code thereon that links the master instant lottery ticket to a ticket-specific computer file;
for each of the master instant lottery tickets, a digital game play area corresponding to the game play area of the master instant lottery ticket, the digital game play area stored in the ticket-specific computer file;
a central server, the ticket-specific computer files stored with the central server, the central server configured for communication with a player's smart device to download the digital game play area to the smart device upon receipt of the ticket-specific code for a specific one of the master instant lottery tickets;
the digital game play area configured such that winning game play indicia therein is marked in a manner recognizable by an application running on the smart device; and
wherein the application on the smart device visually enhances the marked game play indicia in an image of the digital game play area presented to the player via the smart device.

2. The instant lottery ticket game system as in claim 1, wherein the digital game play area is a digital image and the winning game play indicia is marked with a character that is recognized by character recognition capability of the application running on the smart device.

3. The instant lottery ticket game system as in claim 1, wherein the digital game play area is a digital image and the winning game play indicia is marked with a font or color that is different from that of non-winning game play indicia and that is recognized by the application running on the smart device.

4. The instant lottery ticket game system as in claim 1, wherein the marked game play indicia is magnified or enlarged as compared to non-winning game play indicia in the image of the game play area presented to the player.

5. The instant lottery ticket game system as in claim 1, further comprising a digital game instruction area that contains the static game instruction indicia for the common game and is presented to the player with the digital game play area on the smart device.

6. The instant lottery ticket game system as in claim 5, wherein the digital game instruction area is combined and stored with the digital game play area in the ticket-specific computer file at the central server.

7. The instant lottery ticket game system as in claim 5, wherein the digital game instruction area comprises a digital template for the common game that contains the static game instruction indicia, the digital template downloaded by the central server and stored on the player's smart device for subsequent combination with the digital game play area by the application running on the smart device.

8. The instant lottery ticket game system as in claim 1, wherein the ticket-specific code comprises a validation code and the ticket-specific computer file comprises a validation file that contains ticket-specific information for validation and redemption of the master instant lottery ticket, the digital game play area stored in the validation file for the master instant lottery ticket.

9. The instant lottery ticket game system as in claim 1, wherein each of the master instant lottery tickets comprises a symbol or indicia printed thereon that indicates to players that the enhanced digital game play area is available via their smart device.

10. A method for providing an instant lottery ticket game system with visually enhanced presentation of winning tickets to players, comprising:
producing a set of master instant lottery tickets for a common game, wherein each master instant lottery ticket comprises a game play area with variable game play indicia, and static game instruction indicia that is common to all of the master instant lottery tickets in the common game;
on each of the master instant lottery tickets, printing a ticket-specific code thereon that links the master instant lottery ticket to a ticket-specific computer file at a central server;
for each of the master instant lottery tickets, generating a digital game play area corresponding to the game play area of the master instant lottery ticket, and storing the digital game play in the ticket-specific computer file;
configuring the central server for communication with a player's smart device; and
upon receipt of the ticket-specific code via an application running on the player's smart device, the central server downloads the digital game play area for the specific master instant lottery ticket to the smart device;
generation of the digital game play area further comprising marking winning game play indicia in a manner recognizable by the application on the smart device; and
wherein the application on the smart device is configured to visually enhance the marked game play indicia in an image of the digital game play area presented to the player via the smart device.

11. The method as in claim 10, wherein the digital game play area is a digital image and the winning game play indicia is marked with a character that is recognized by character recognition capability of the application running on the smart device.

12. The method as in claim 10, wherein the digital game play area is a digital image and the winning game play indicia is marked with a font or color that is different from that of non-winning game play indicia and that is recognized by the application running on the smart device.

13. The method as in claim 10, wherein the marked game play indicia is magnified or enlarged as compared to non-winning game play indicia in the image of the game play area presented to the player.

14. The method as in claim 10, further comprising generating a digital game instruction area that contains the static game instruction indicia for the common game and presented the digital game instruction area to the player with the digital game play area on the smart device.

15. The method as in claim 14, wherein the digital game instruction area is combined and stored with the digital game play area in the ticket-specific computer file at the central server.

16. The method as in claim 14, wherein the digital game instruction area is generated as a digital template for the common game that contains the static game instruction indicia, the digital template downloaded by the central server and stored on the player's smart device for subsequent combination with the digital game play area by the application on the smart device.

17. The method as in claim 10, wherein the ticket-specific code comprises a validation code and the ticket-specific computer file comprises a validation file that contains ticket-specific information for validation and redemption of the master instant lottery ticket, the digital game play area stored in the validation file for the master instant lottery ticket.

18. The method as in claim 10, further comprising printing a symbol or indicia on the master instant lottery tickets that indicates to players that the enhanced digital game play area is available via their smart device.
